(19) United States
(12) Patent Application Publication
(10) Pub. No.: US 2012/0013623 A1
(43) Pub. Date: Jan. 19, 2012

(54) HOST COMPUTER AND METHOD FOR ADJUSTING DISPLAY PARAMETERS

(75) Inventors: YUN-SHAN XIAO, Shenzhen City (CN); HAI-QING ZHOU, Shenzhen City (CN); ZHENG-QUAN PENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/171,463

(22) Filed: Jun. 29, 2011

(30) Foreign Application Priority Data
Jul. 13, 2010 (CN) 201010224862.4

(51) Int. Cl. G06F 13/14

(52) U.S. Cl. 345/520

(57) ABSTRACT

A method for adjusting display parameters of a monitor connected to a host computer. The host computer includes a video card. If the monitor cannot display data normally, the method selects a group of display parameters C2, which has not been used by the monitor, and is applicable to both the video card and the monitor, and sets the parameters in the selected group of display parameters C2 as the preferred display parameters of the monitor.

### BACKGROUND

1. Technical Field

Embodiments of the present disclosure generally relate to electronic device management, and more particularly to a host computer and a method for adjusting display parameters of a monitor connected to the host computer.

2. Description of Related Art

Display parameters such as resolution, color level, dot pitch and refresh rate, are very relevant for a monitor connected to a host computer. If some display parameters are set incorrectly, the monitor cannot display data normally. Sometimes a monitor needs to be replaced, but if the new monitor does not display data normally under the display parameters of the previous monitor, then the user may have to use the previous monitor to adjust the display parameters which is time-consuming and very inconvenient.

### BRIEF DESCRIPTION OF THE DRAWINGS

FIG. 1 is a block diagram of one embodiment of a host computer including an adjustment system for adjusting display parameters of a monitor connected to the host computer.

FIG. 2 is a block diagram of one embodiment of function modules of the adjustment system of FIG. 1.

FIG. 3 is a flowchart of one embodiment of a method for adjusting display parameters of the monitor connected to the host computer of FIG. 1.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used hereinafter, refers to logic embodied in hardware or firmware, or to a collection of software instructions, written in a programming language, such as, Java, C, or assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

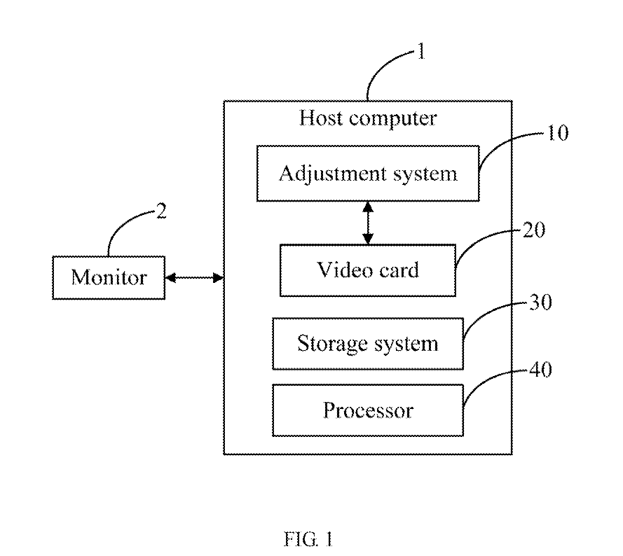

FIG. 1 is a block diagram of one embodiment of a host computer 1 including an adjustment system 10 for adjusting display parameters of a monitor 2 connected to the host computer 1. In one embodiment, the host computer 1 further includes a video card 20. The host computer 1 may be a personal computer or a server or similar.

The display parameters comprise resolutions, color levels, dot pitch distances, refresh rates and certain other parameters of the monitor 2. These parameters determine quality of the display of the monitor 2, such as image definition and image stability.

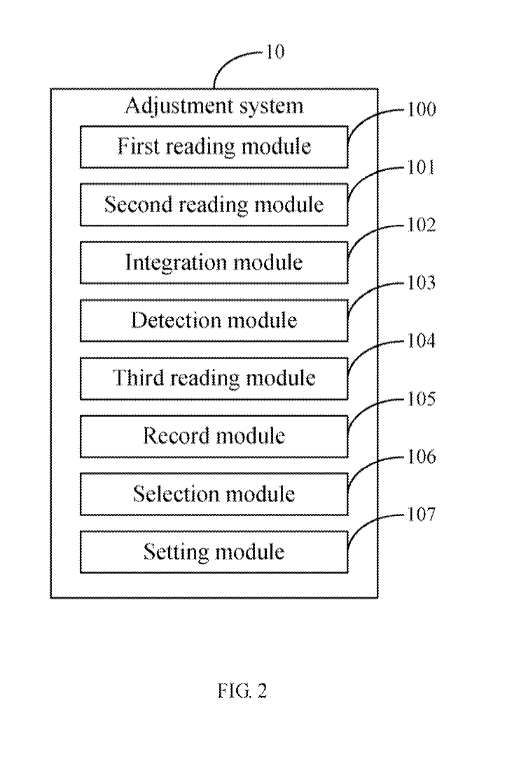

In one embodiment, the adjustment system 10 may include one or more function modules (detailed description is given in FIG. 2). The one or more function modules may comprise computerized code in the form of one or more programs that are stored in a storage system 30, and executed by a processor 40 of the host computer 1 to provide the functions of the adjustment system 10 described later. Depending on the embodiment, the storage system 30 may be a memory system of the host computer 1.

FIG. 2 is a block diagram of one embodiment of function modules of the adjustment system 10 of FIG. 1. In one embodiment, the management system 10 includes a first reading module 100, a second reading module 101, an integration module 102, a detection module 103, a third reading module 104, a record module 105, a selection module 106, and a setting module 107.

The first reading module 100 is operable to read a first display parameters combination P1 from the video card 20. The first display parameters combination P1 is a combination of the particular parameters applicable to the video card 20, such as resolutions, color levels, dot pitch distances, and refresh rates of the video card 20. The video card 20 can work normally with the first display parameters combination P1. The first display parameters, in one example, may be default display parameters of the video card 20.

The second reading module 101 is operable to read a second display parameters combination P2 from the monitor 2. The second display parameters combination P2 is a combination of the particular parameters applicable to the monitor 2, such as resolutions, color levels, dot pitch distances, and refresh rates of the monitor 2. The monitor 2 can display data normally with the second display parameters combination P2. The second display parameters, in one example, may be default display parameters of the monitor 2.

The integration module 102 is operable to generate a third display parameters combination P3 which is a combination of the particular parameters applicable to both the video card 20 and the monitor 2, such as resolutions, color levels, dot pitch distances, and refresh rates. The third display parameters combination P3 is an intersection of the first display parameters combination P1 and the second display parameters combination P2. Either or both of the video card 20 and the monitor 2 can work normally with the third display parameters combination P3. That is, the third display parameters are parameters that are common to both the video card 20 and the monitor 2.

The detection module 103 is operable to detect whether the monitor 2 is displaying data normally. In some embodiments, if the monitor 2 can display the image clearly and stably within display range of the monitor 2, the monitor 2 is displaying data normally. If the monitor 2 can not display the image clearly or stably, or the image beyond display range of the monitor 2, the monitor 2 is not displaying data normally.

The third reading module 104 is operable to read a display parameters group C1 from the monitor 2 upon the condition that the monitor 2 is not displaying data normally. The display parameters group C1 is a group of the current display parameters of the monitor 2.

The record module 105 is operable to add the display parameters group C1 to a fourth display parameters combination P4. The fourth display parameters combination P4 records all the display parameters which have been used by the monitor 2.

The selection module 106 is operable to select a group of display parameters C2 which falls within the third display parameters combination P3 but is excluded from the fourth display parameters combination P4.

The setting module 107 is operable to set certain parameters in the selected group of display parameters C2 as the preferred display parameters of the monitor 2.

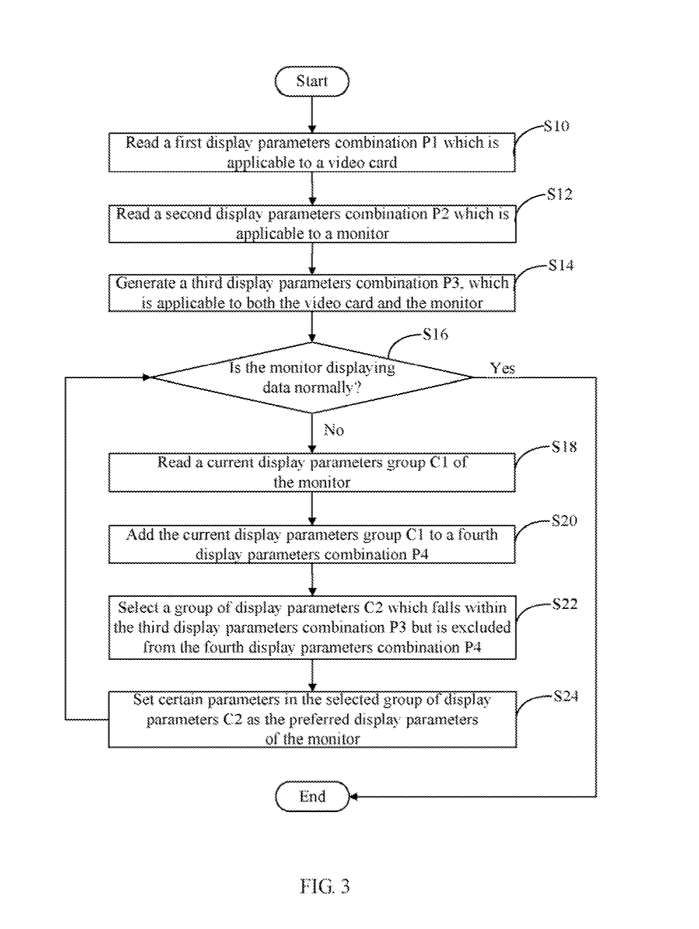

FIG. 3 is a flowchart of one embodiment of a method for adjusting display parameters of the monitor 2 connected to the host computer 1 of FIG. 1. Depending on the embodiment, additional blocks may be added, others removed, and the ordering of the blocks may be changed.

In block S10, the first reading module 100 reads a first display parameters combination P1 from the video card 20. The first display parameters combination P1 is a combination of the particular parameters applicable to the video card 20, such as resolutions, color levels, dot pitch distances, and refresh rates of the video card 20. The video card 20 can work normally with the first display parameters combination P1. The first display parameters, in one example, may be default display parameters of the video card 20.

In block S12, the second reading module 101 reads a second display parameters combination P2 from the monitor 2. The second display parameters combination P2 is a combination of the particular parameters applicable to the monitor 2, such as resolutions, color levels, dot pitch distances, and refresh rates of the monitor 2. The monitor 2 can display data normally with the second display parameters combination P2. The second display parameters, in one example, may be default display parameters of the monitor 2.

In block S14, the integration module 102 generates a third display parameters combination P3, which is a combination of the particular parameters applicable to both the video card 20 and the monitor 2, such as resolutions, color levels, dot pitch distances, and refresh rates. The third display parameters combination P3 is an intersection of the first display parameters combination P1 and the second display parameters combination P2. Either or both of the video card 20 and the monitor 2 can work normally with the third display parameters combination P3. That is, the third display parameters are parameters that are common to both the video card 20 and the monitor 2.

In block S16, the detection module 103 detects whether the monitor 2 is displaying data normally. In some embodiments, if the monitor 2 can display the image clearly and stably within display range of the monitor 2, the monitor 2 is displaying data normally. If the monitor 2 can not display the image clearly or stably, or the image beyond display range of the monitor 2, the monitor 2 is not displaying data normally. If the display is normal, the procedure ends, otherwise block S18 is implemented.

In block S18, the third reading module 104 reads a display parameters group C1 from the monitor 2 upon the condition that the monitor 2 is not displaying data normally. The display parameters group C1 is a group of the current display parameters of the monitor 2.

In block S20, the record module 105 adds the display parameters group C1 to a fourth display parameters combination P4. The fourth display parameters combination P4 records all the display parameters which have been used by the monitor 2.

In block S22, the selection module 106 selects a group of display parameters C2 which falls within the third display parameters combination P3 but is excluded from the fourth display parameters combination P4.

In block S24, the setting module 107 sets certain parameters in the selected group of display parameters C2 as the preferred display parameters of the monitor 2, and the procedure returns to block S16 until the monitor 2 is displaying data normally.

Although certain inventive embodiments of the present disclosure have been specifically described, the present disclosure is not to be construed as being limited thereto. Various changes or modifications may be made to the present disclosure beyond departing from the scope and spirit of the present disclosure.

What is claimed is:

1. A method for adjusting display parameters of a monitor connected to a host computer, the host computer comprising a video card, the method comprising:
(a) reading a first display parameters combination P1 from the video card, the first display parameters combination P1 being a combination of the particular parameters applicable to the video card;
(b) reading a second display parameters combination P2 from the monitor, the second display parameters combination P2 being a combination of the particular parameters applicable to the monitor;
(c) generating a third display parameters combination P3, the third display parameters combination P3 being an intersection of the first display parameters combination P1 and the second display parameters combination P2;
(d) detecting whether the monitor is displaying data normally;
(e) in response to the monitor not displaying data normally, reading a display parameters group C1 from the monitor, the display parameters group C1 being a group of the current display parameters of the monitor;
(f) adding the display parameters group C1 to a fourth display parameters combination P4;
(g) selecting a group of display parameters C2 that falls within the third display parameters combination P3 but is excluded from the fourth display parameters combination P4; and
(h) setting certain parameters in the selected group of display parameters C2 as the preferred display parameters of the monitor, and returning to block (d) until the monitor is displaying data normally.

2. The method as claimed in claim 1, wherein the display parameters of the monitor comprise resolutions, color levels, dot pitch distances, and refresh rates of the monitor.

3. The method as claimed in claim 1, wherein the host computer is a personal computer or a server.

4. The method as claimed in claim 1, wherein the third display parameters combination P3 is an intersection of the first display parameters combination P1 and the second display parameters combination P2.

5. A non-transitory storage medium storing a set of instructions, the set of instructions capable of being executed by a processor to perform a method for adjusting display parameters of a monitor connected to a host computer, the host computer comprising a video card, the method comprising:
(a) reading a first display parameters combination P1 from the video card, the first display parameters combination P1 being a combination of the particular parameters applicable to the video card;
(b) reading a second display parameters combination P2 from the monitor, the second display parameters combination P2 being a combination of the particular parameters applicable to the monitor;
(c) generating a third display parameters combination P3, the third display parameters combination P3 being an intersection of the first display parameters combination P1 and the second display parameters combination P2;
(d) detecting whether the monitor is displaying data normally;
(e) in response to the monitor not displaying data normally, reading a display parameters group C1 from the monitor, the display parameters group C1 being a group of the current display parameters of the monitor;
(f) adding the display parameters group C1 to a fourth display parameters combination P4;
(g) selecting a group of display parameters C2 that falls within the third display parameters combination P3 but is excluded from the fourth display parameters combination P4; and
(h) setting certain parameters in the selected group of display parameters C2 as the preferred display parameters of the monitor, and returning to block (d) until the monitor is displaying data normally.

6. The non-transitory storage medium as claimed in claim 5, wherein the display parameters of the monitor comprise resolutions, color levels, dot pitch distances, and refresh rates of the monitor.

7. The non-transitory storage medium as claimed in claim 5, wherein the host computer is a personal computer or a server.

8. The non-transitory storage medium as claimed in claim 5, wherein the third display parameters combination P3 is an intersection of the first display parameters combination P1 and the second display parameters combination P2.

9. A host computer, the host computer being connected to a monitor, the host computer comprising:
a storage system;
a video card;
at least one processor; and
one or more programs stored in the storage system, executable by the at least one processor, the one or more programs comprising:
a first reading module operable to read a first display parameters combination P1 from the video card, the first display parameters combination P1 being a combination of the particular parameters applicable to the video card;
a second reading module operable to read a second display parameters combination P2 from the monitor, the second display parameters combination P2 being a combination of the particular parameters applicable to the monitor;
a integration module operable to generating a third display parameters combination P3, the third display parameters combination P3 being an intersection of the first display parameters combination P1 and the second display parameters combination P2;
a detection module operable to detect whether the monitor is displaying data normally;
a third reading module operable to read a display parameters group C1 from the monitor in response to the monitor not displaying data normally, the display parameters group C1 being a group of the current display parameters of the monitor;
a record module operable to add the display parameters group C1 to a fourth display parameters combination P4;
a selection module operable to select a group of display parameters C2 that falls within the third display parameters combination P3 but is excluded from the fourth display parameters combination P4; and
a setting module operable to set certain parameters in the selected group of display parameters C2 as the preferred display parameters of the monitor.

10. The host computer as claimed in claim 9, wherein the display parameters of the monitor comprise resolutions, color levels, dot pitch distances, and refresh rates of the monitor.

11. The host computer as claimed in claim 9, wherein the host computer is a personal computer or a server.

12. The host computer as claimed in claim 9, wherein the third display parameters combination P3 is an intersection of the first display parameters combination P1 and the second display parameters combination P2.
